(19) United States
(12) Patent Application Publication
(10) Pub. No.: US 2003/0169311 A1
(43) Pub. Date: Sep. 11, 2003

(54) Optical encoder device, optical encoder arrangement, inkjet printer and method for estimating a motion information

(76) Inventors: Teng Kong Leong, Penang (MY); Lim Chin Yee, Selangor Darul Ehsan (MY)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/359,453

(22) Filed: Feb. 5, 2003

(30) Foreign Application Priority Data
Mar. 5, 2002 (MY) PI20020781

(51) Int. Cl. B41J 29/393

(52) U.S. Cl. 347/19

(57) ABSTRACT

The invention relates to an optical encoder device, an optical encoder arrangement, an inkjet printer and a method for estimating a motion information. The optical encoder device of the invention comprises a movable optical encoding unit comprising a plurality of alternating transparent and opaque encoding elements and being arranged such that at least a part of the encoding elements can be illuminated with light. The optical encoder device has at least two optical detecting elements grouped to at least one pair. Moreover, the optical encoder device comprises an encoding filter comprising a plurality of alternating transparent and opaque filter elements, wherein the encoding elements of the optical encoding unit, the filter elements of the encoding filter and the at least one pair of optical detecting elements are arranged relative to each other such that the optical detecting elements of the pair can be complementarily illuminated with light transmitted through the optical encoding unit and the encoding filter. Beyond this, the optical encoder device includes an estimation unit coupled to the optical detecting elements such that detection signals from at least the pair of optical detecting elements can be provided to the estimation unit, wherein the estimation unit is adapted to estimate a motion information, which is characteristic for a motion of the movable optical encoding unit, based on the detection signals of the pair of optical detecting elements.

### BACKGROUND OF THE INVENTION

1. Field of the Invention

The present invention relates to an optical encoder device, an optical encoder arrangement, an inkjet printer and a method for estimating a motion information.

2. Description of the Related Art

The demand for precise and accurate encoding devices coincides with the growing complexity of the industrial and consumer products being developed. A huge portion of the automation machinery operates through complex feedback control systems, requiring continuous and accurate position and direction feedback. Presently, most encoders are interfaced with electronic controllers or counters that amplify the generated encoder resolution seen by a system. The interface of an encoder with the electronics technology is perceived to the best solution to satisfy the current demand, but, as one moves into a higher resolution region, the electronic solution might not be able to continuously support the next level of bandwidth range.

An encoder is a device that provides feedback to a closed loop system. An encoder enables a signal interpretation such as to obtain information on a position, a velocity, an acceleration and/or the like when the encoder is operated with a moved codewheel or a codestrip. Codewheels are generally used for detecting a rotation motion, for example of a paper feeder drum in a printer or a copy machine, while codestrips are used for detecting a linear motion, for example of a printhead of a printer.

The brain of a printer is its microprocessor which communicates with an attached personal computer, manages image data and controls electronic and mechanical activity of the printer. Motion encoders and control electronics bridge the gap between the microprocessor and mechanical activity such as positioning the print heads and moving the paper. It is the job of the microprocessor not only to control motion but also to determine motion and position to obtain the information, e.g., where the print head is on a page. An optical encoder which measures linear or rotary motion often accomplishes translating motion into an electronic signal. In the rotary case, a codewheel is attached to the shaft of a small motor, which, in a printer, drives the print head carriage of paper transport mechanisms. The outer edge of the codewheel usually has precisely manufactured openings that pass between a light-emitting diode, and a photodetector reading the pulses of light passing through the openings. The encoder sends pulse information to the motion controller which then can measure and correct the speed, position and direction of the motor shaft.

Thus, the motion of the codewheel or the codestrip is detected optically by means of an optical emitter and an optical detector. Therefore, the encoder is usually an optical encoder. The optical emitter emits light in a light direction towards the codewheel or the codestrip. The codewheel or the codestrip comprises a regular pattern of slots and bars. According to the position of the slots and bars, relative to the light emission direction, the codewheel or codestrip sometimes permits and sometimes prevents light passing through the slots. The optical detector is positioned behind the codewheel or codestrip when seen in the direction of the light emission by the optical emitter, and detects a light signal, based on the light emitted by the optical emitter and transmitted through the codewheel or codestrip. The time dependence, e.g. the frequency, of the light signal yields characteristic and unambiguous information concerning the motion of the codewheel or the codestrip.

Due to this special arrangement of the optical emitter and the optical detector of such an optical encoder, the optical encoder housing for accommodating the optical encoder is generally C-shaped. The optical encoder together with the C-shaped optical encoder housing form a C-shaped optical encoder device. The codewheel or codestrip is moved through the free space of the C-shaped optical encoder device such that the optical encoder can detect the slots and bars of the codewheel or the codestrip.

The resolution of optical encoder devices known from the prior art depends on the size, particularly depends on the lateral dimensions of photodetectors and slots of the codewheel or codestrip.

However, there is a demand for higher encoder resolution which is expanding side by side with the technology pace.

One idea how to achieve a better resolution is decreasing the size of the photodetector to match a miniaturize codewheel bar and window size. However, this concept presents difficulties, as it reduces the photo current to a level, that a pre-amplifier of the electronics cannot compensate. Moreover, the signal-to-noise-ratio can become worse with a decreasing amount of photo current. Further, when reducing the size of the components of an optical encoder device, the system behaviour is critical concerning the sensitivity of the alignment. Thus, a simple miniaturization of the components of an optical encoder device is not suitable for achieving a better resolution.

According to a technique widely implemented in the optical encoder product, a counter and a controller are used to detect the falling and rising edges of signals of photodetectors. Using this concept, the resolution can be improved compared to the base encoder resolution. Moreover, incorporating interpolation process into counter and controller technique further elevates the resolution level. However, there are doubts whether the present electronics technology can support higher bandwidth level.

### SUMMARY OF THE INVENTION

It is an object of the present invention to provide an optical encoding with an improved resolution compared to the related art.

The object is achieved by providing an optical encoder device, an optical encoder arrangement, an inkjet printer and a method for estimating a motion information with the features according to the independent claims.

An optical encoder device according to a first main aspect of the invention, comprises a movable optical encoding unit comprising a plurality of alternating transparent and opaque encoding elements and being arranged such that at least a part of the encoding elements can be illuminated with light. The optical encoder device further comprises at least two optical detecting elements grouped to at least one pair. Moreover, the optical encoder device has an encoding filter comprising a plurality of alternating transparent and opaque filter elements, wherein the encoding elements of the optical encoding units, the filter elements of the encoding filter and the at least one pair of optical detecting elements are arranged relative to each other such that the optical detecting elements of the pair can be complementarily illuminated with light transmitted through the optical encoding unit and the encoding filter. Beyond this, the optical encoder device has an estimation unit coupled to the optical detecting elements such that light detection signals from at least the pair of optical detecting elements can be provided to the estimation unit, wherein the estimation unit is adapted to estimate a motion information (e.g. a velocity, acceleration, etc.), which is characteristic for a motion of the movable optical encoding unit, based on the detection signals of the pair of optical detecting elements.

According to a second main aspect of the invention, an optical encoder arrangement is provided comprising the above-mentioned elements of the optical encoder device and additionally, a light source arranged such that it is capable of emitting light onto at least a part of the encoding elements.

According to a third main aspect of the invention an inkjet printer is provided comprising an optical encoder arrangement with the above-described features.

According to a fourth main aspect of the invention, a method for estimating a motion information, which is characteristic for a motion of a movable optical encoding unit of an optical encoding device is provided. The optical encoder device is arranged as the optical encoder device according to the first main aspect of the invention. The method comprises the steps of illuminating at least a part of the encoding elements with light, providing detection signals from at least the pair of optical detecting elements to the estimation unit and estimating a motion information which is characteristic for a motion of the movable optical encoding unit, based on the detection signals of the pair of optical detecting elements.

One basic idea of the invention is to provide an encoding filter for an optical encoder device and to arrange the encoding elements of the optical encoding unit, the filter elements of the encoding filter and the at least one pair of optical detecting elements relative to each other such that the optical detecting elements of the pair can be complementarily illuminated with light transmitted through the optical encoding unit and the encoding filter. “Complementary illumination” in this context means that preferably one optical detecting element of the pair of optical detecting elements has a first group of portions illuminated by light and a second portion not illuminated by light, while the other optical detecting element of the pair of optical detecting elements has the corresponding first group of portions free from an illumination by light and the second group of portions illuminated by light. “Portions” of the optical detecting elements in this context means parts of the surface area of the optical detecting elements which are covered by or which are free from an opaque cover, respectively. Therefore, the light and shadow patterns of the two complementary optical detecting elements of the pair of optical detecting elements are basically complementary or, in other words, inverse to each other. The degree of being complementary can also be only partially. Complementary illumination can have the consequence that the detection signals of the pair of optical detecting elements are at least partially out of phase. Thus, the detection signals of the pair of optical detecting elements give in some sense complementary information which is used by the estimation unit to estimate a motion information with an improved resolution. With the movable optical encoding unit together with its alternating transparent and opaque encoding elements moving with respect to the encoding filter and the optical detecting elements, the light and shadow pattern of the two optical detecting elements forming the pair changes with the time. This time-dependence is characteristic for the motion of the movable optical encoding unit.

Utilizing a pattern printing technique for a high resolution purpose introduces advantages over other high resolution techniques. Pattern printing on the movable optical encoding unit (e.g. a codewheel or a codestrip) and the encoding filter is reaching new height over the years, compressing more encoding elements and filter elements per inch. Therefore, the concept of the invention demands lower costs as compared to other techniques.

It is a further advantage of the invention that present electronic circuits on optical encoder products that process waveforms into outputs (e.g. TTL-outputs, transistor-transistor-logic) require only minimum modification to be adapted to the concept of the invention. Thus, it is provided an easy path of integrating the technique of the invention into current optical encoder products.

Relieving on commercially available electronic circuit, and the existence of advanced printing technology places the pattern printing technique the invention is directed to, as an interesting alternative to presently available techniques of achieving high resolution with an optical encoder device. With minor modifications on the electronic circuitry and less or none alignment issue, the technique of the invention can easily be realized to obtain a higher resolution optical encoder.

As the invention teaches a new concept to position the encoding elements of the movable optical encoding unit with respect to the optical detecting elements, the limitations of the technologies is no longer determined by the electronics components.

In the following, preferred embodiments of the optical encoder device will be described. Preferred embodiments of the optical encoder device can be used as well for the optical encoder arrangement.

The above and other aspects, features and advantages of the present invention will become apparent from the following description and the appended claims, taken in conjunction with the accompanying drawings.

### BRIEF DESCRIPTION OF THE DRAWINGS

The accompanying drawings which are included to provide a further understanding of the invention and constitute a part of the specification, illustrate embodiments of the invention.

In the drawings:

FIG. 1A is a cross-sectional view of an optical decoder arrangement according to a preferred embodiment of the invention,

FIG. 1B is a side view of the optical encoder arrangement shown in FIG. 1A,

FIG. 1C is a cross-sectional view of an optical encoder arrangement according to another preferred embodiment of the invention,

FIG. 1D is a side view of the optical encoder arrangement shown in FIG. 1C,

FIG. 2A is a plan view showing an arrangement of four optical detecting elements of an optical encoder device according to a preferred embodiment of the invention,

FIG. 2B is a plan view showing an encoding filter of an optical encoder device according to the preferred embodiment of the invention,

FIG. 2C is a plan view showing a sector of a movable optical encoding unit of the optical encoder device according to the preferred embodiment of the invention,

FIG. 2D is a plan view showing the combination of the encoding filter from FIG. 2B stacked on the optical detecting elements of FIG. 2A,

FIGS. 3A to 3D are plan views of a combination of the sector of the movable optical encoding unit of FIG. 2C which is stacked on the encoding filter of FIG. 2B which is stacked on the array of optical detecting elements of FIG. 2A at different times during a motion of the movable optical encoding unit,

FIG. 4A is a diagram showing the time-dependence of the waveforms of the detection signals detected by the four individual optical detecting elements shown in FIG. 2A during a motion of the movable optical encoding unit shown in FIG. 2C,

FIG. 4B is a diagram showing a waveform signal as estimated by the estimation unit from the detection signals of the optical detecting elements in the first and the third row shown in FIG. 2A,

FIG. 4C is a diagram showing a waveform signal as estimated by the estimation unit from the detection signals of the optical detecting elements in the second and the fourth row shown in FIG. 2A,

FIG. 5 is a schematic view of an optical encoder arrangement according to a further preferred embodiment of the invention.

### DESCRIPTION OF PREFERRED EMBODIMENTS OF THE INVENTION

Preferred embodiments of the invention will now be described with reference to the accompanying drawings in which like parts or elements are denoted be like reference numbers.

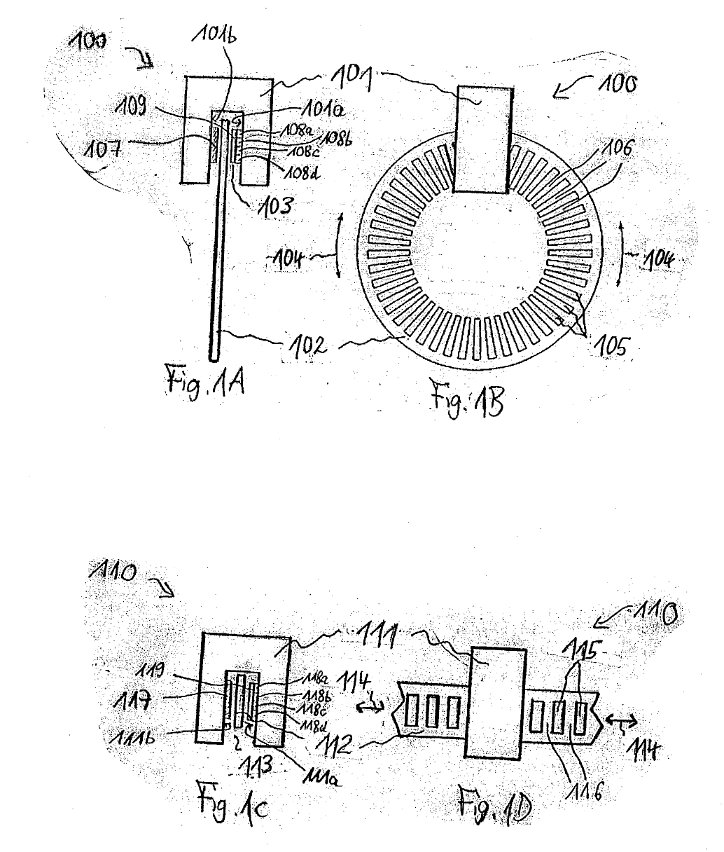

In the following, referring to FIG. 1A, FIG. 1B, a preferred embodiment of the optical encoder arrangement of the invention will be described.

In FIG. 1A, FIG. 1B, a cross-section and a side view of an optical encoder arrangement 100 according to a preferred embodiment of the invention is illustrated. The optical encoder arrangement 100 comprises a generally C-shaped housing 101 having a first inner surface 101a and a second inner surface 101b which are generally parallel to each other, wherein four photodetectors 108a to 108d are provided on the first surface 101a, wherein a light-emitting diode 107 is provided on the second surface 101b and wherein a part of a codewheel 102 is arranged in a free space 103 between the first and second surfaces 101a, 101b of the generally C-shaped housing 101. An encoding filter 109 is provided on the photodetectors 108a to 108d on the first surface 101a of the housing 101.

The codewheel 102 is adapted such that it can be rotated around an axis of the codewheel 102. The rotation direction is indicated by the arrows 104. Along a circumference of the codewheel 102, a plurality of alternating slots 105 and bars 106 are provided. Light emitted from the light-emitting diode 107 can pass through the slots 105 of the rotating codewheel 102 such that the photodetectors 108a to 108d detect pulses being characteristic for the motion of codewheel 102, provided that light is not prevented from passing from the light-emitting diode 107 through a slot 105 and through the encoding filter 109 to one of the photodetectors 108a to 108d.

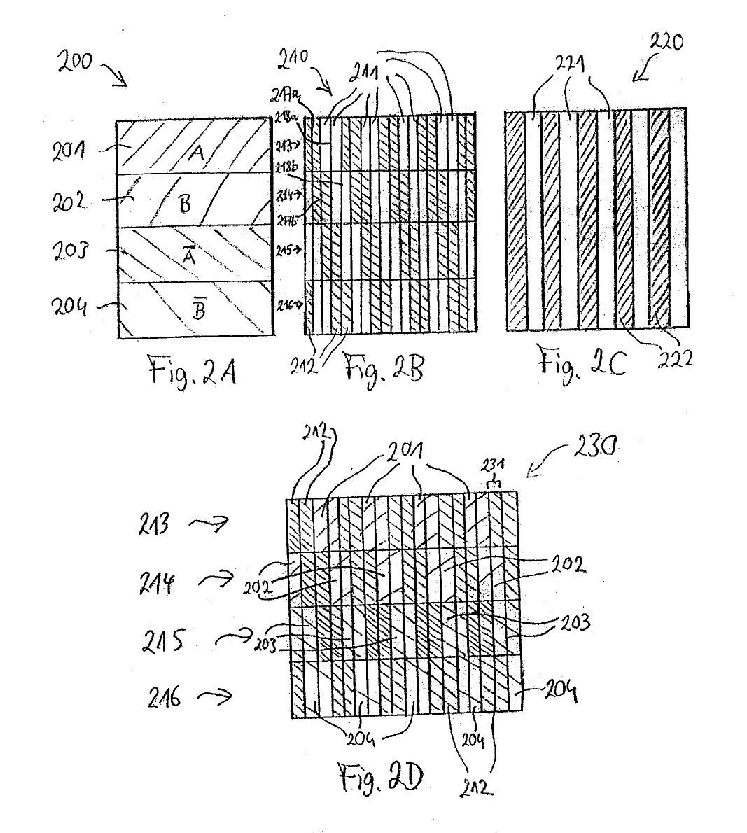

The alignment direction of the slots 105 and bars 106 of the part of the codewheel 102 located within the C-shaped housing 101 is in the manner as shown in FIG. 2C and is generally perpendicular to the alignment direction of the photodetectors 108a to 108d, which is in the manner as shown in FIG. 2A. The encoding filter 109 comprises a plurality of opaque and transparent portions in a manner as shown in FIG. 2B, for instance. The functionality of the optical encoder arrangement 100 can be understood in detail from the description referring to FIG. 2A to FIG. 4D.

It should be noted that the dimension of the codewheel 102 is usually substantially larger than the dimension of the slots 105 and bars 106, the photodetectors 108a to 108d, the encoding filter 109 and the light-emitting diode 107 (compare FIG. 1A, FIG. 1B). Thus, the curvature of the arrangement of the slots 105 and bars 106 located within the free space 103 may be neglected in a first approximation. In other words, adjacent slots are almost parallel to each other. In this case, the slots 105 and bars 106, the photodetectors 108a to 108d, the encoding filter 109 and the light-emitting diode 107 can be brought in a proper alignment with each other, when being formed in a basically rectangular shape. However, any deviation of the shape of the slots 105 from a rectangular shape and from a parallel orientation with respect to neighboured slots 105 may be compensated by properly adjusting the shape of the photodetectors 108a to 108d, the encoding filter 109 and the light-emitting diode 107 to the shape of slots 105 and bars 106.

The optical encoder arrangement 100 is located within an inkjet printer (not shown), the codewheel 102 being attached to the shaft of a motor driving the print head carriage of paper transport mechanism.

In the following, referring to FIG. 1C, FIG. 1D, another preferred embodiment of the optical encoder arrangement of the invention will be described.

In FIG. 1C, FIG. 1D, a cross-section and a side view of an optical encoder arrangement 110 according to another preferred embodiment of the invention is illustrated.

The optical encoder device 110 comprises a generally C-shaped housing 111 and a codestrip 112, a part of which is located within a free space 113 of the C-shaped housing 111. The codestrip 112 comprises a plurality of slots 115 and bars 116, such that light emitted from a light-emitting diode 117 can pass through the slots 115 of the codestrip 112 and impinges on one of four photodetectors 118a to 118d to generate a detection signal, provided that the light can pass through an encoding filter 119 which is located on the array of photodetectors 118a to 118d and which is formed by a plurality of alternating transparent and opaque portions. If the codestrip 112 performs a translational motion (compare motion arrows 114), the photodetectors 118a to 118d detect light pulses with a temporal pulse sequence being characteristic for the motion of the codestrip 112, e.g. characteristic for its velocity.

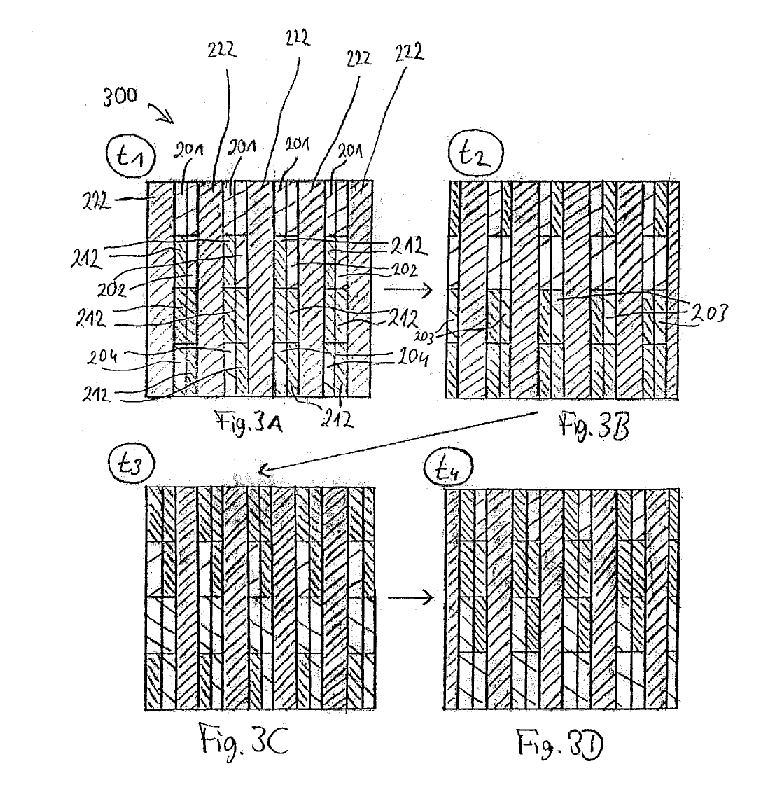

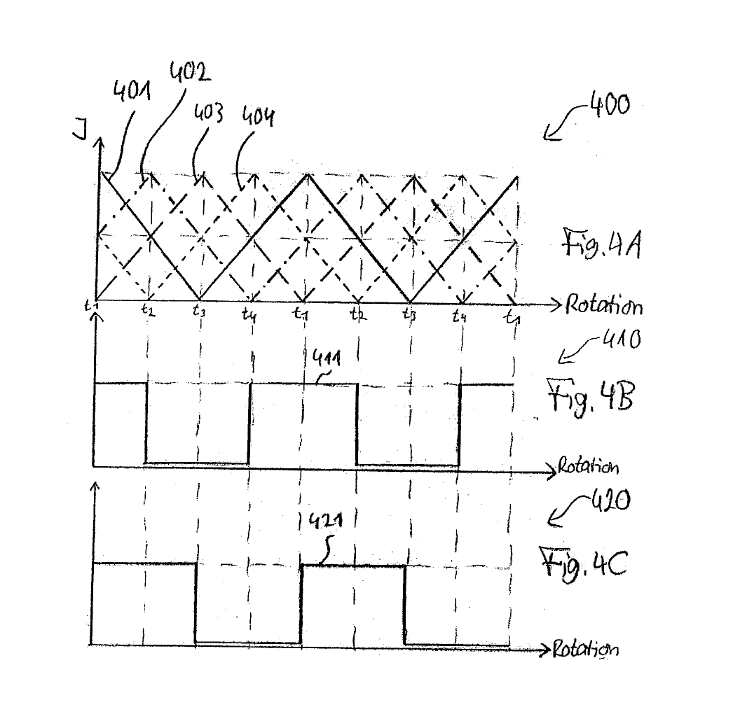

In the following, a preferred embodiment of the optical encoder device of the invention and its functionality will be described in detail referring to FIG. 2A to FIG. 2D, FIG. 3A to FIG. 3D and FIG. 4A to FIG. 4C.

In FIG. 2A, an array 200 of a first photodiode 201, a second photodiode 202, a third photodiode 203 and a fourth photodiode 204 as optical detecting elements of the optical encoder device are shown. As further shown in FIG. 2A, the four photodiodes 201 to 204 are oriented generally parallel to each other and along an alignment direction which is vertical according to FIG. 2A. Further, the four photodiodes 201 to 204 are grouped to two pairs, a first pair of photodiodes formed by the first photodiode 201 and the third photodiode 203 and a second pair formed by the second photodiode 202 and the fourth photodiode 204. As will be described below, the combined functionality of the array of optical detecting elements 200 shown in FIG. 2A, an encoding filter 210 shown in FIG. 2B and an optical encoding unit 220 shown in FIG. 2C is such that the first and the third photodiodes 201, 203 can be illuminated by light in a complementary manner, and the second and the fourth photodiodes 202, 204 can be illuminated by light in a complementary manner. To indicate this complementary functionality, photodiodes 201 and 203 are denoted as A and \overline{A}, respectively, whereas photodiodes 202 and 204 are denoted as photodiodes B and \overline{B}, respectively.

Referring now to FIG. 2B, an encoding filter 210 is shown comprising a plurality of alternating transparent filter elements 211 and opaque filter elements 212. The transparent filter elements 211 are arranged such that light can pass through the transparent filter elements 211, whereas the opaque filter elements 212 are arranged such that light is prevented from passing through the opaque filter elements 212. As further shown in FIG. 2B, the encoding filter 210 comprises four rows 213, 214, 215, 216, each row 213 to 216 corresponding to and being in alignment with one of the photodiodes 201 to 204. Each row 213 to 216 comprises a plurality of alternating transparent filter elements 211 and opaque filter elements 212.

Referring to FIG. 2C, a sector 220 of a codewheel (which may be the part of codewheel 102 which part is located within the free space 103 of the C-shaped housing 101 of FIG. 1A, FIG. 11B) is shown comprising a plurality of alternating transparent encoding elements 221 and opaque encoding elements 222 and being arranged such that the encoding elements 221, 222 of the sector 220 can be illuminated with light. The alignment direction of the transparent filter elements 221 and the opaque filter elements 222 of the codewheel 220 is horizontal according to FIG. 2C. In other words, the photodiodes 201 to 204 are aligned along a direction which is generally perpendicular to the alignment direction of the encoding elements 221, 222.

As can be seen from FIG. 2A to FIG. 2C, the alternating transparent and opaque filter elements 211, 212 are arranged generally parallel to the encoding elements 221, 222. Further, the width of the encoding elements 221, 222 equals to the width of the filter elements 211, 212 in lateral direction according to FIG. 2B, FIG. 2C. Further, the first pair of photodiodes 201, 203 is formed by photodiodes aligned with the first and third rows 213, 215, and the second pair of photodiodes 202, 204 is formed by photodiodes aligned with the second and fourth rows 214, 216 of the encoding filter 210, respectively. Corresponding filter elements (for instance first particular opaque encoding element 217a and second particular opaque encoding element 217b or first particular transparent encoding element 218a and second particular transparent encoding element 218b) of the first and second rows 213, 214 are dephased relative to each other by the half of a width of the filter elements 211, 212. The same statement is true for corresponding filter elements 211, 212 of the third and the fourth rows 215, 216.

In contrast to the conventional alignment, the alignment direction of photodiodes 201 to 204 is perpendicular to the codewheel pattern, i.e. the alignment direction of the transparent encoding elements 221 and the opaque encoding elements 222. The number of rows 213 to 216 of the encoding filter 210 equals to the number of photodiodes 201 to 204. With present printing capability, the amount of transparent encoding elements 221 and opaque encoding elements 222 (which also can be realized as slotted portions and non-slotted portions of a solid body) per length is rising to an increased level. According to the described embodiment, the transparent encoding elements 221 and the opaque encoding elements 222, which can also be denoted as bars and windows of the codewheel 220, have the same width as the transparent filter elements 211 and the opaque filter element 212 of the encoding filter 210. As can be further seen from FIG. 2B, rows 213 to 216 of the encoding filter 210 are displaced by certain “electrical degree”, in other words, there is a dephasing between the arrangement of opaque and transparent filter elements 211, 212 in different rows.

It should further be mentioned that FIG. 2C only shows a sector 220 of a codewheel, i.e., a part of the circumferential end portion according to a relatively small angular sector of the codewheel.

FIG. 2D shows a plan view of a combination 230 of the encoding filter 210 and the array 200 of photodiodes 201 to 204, wherein encoding filter 210 is placed on array 200. Combining the photodiodes 201 to 204 and the encoding filter 210, the pattern shown in FIG. 2D is generated. As can be understood from FIG. 2D, an electrical 90 degree offset of the exposed or covered areas of the photodiodes with respect to its neighbouring photodiodes is formed due to the presence of the encoding filter 210. In other words, the spatial light-and-shadow pattern in each row 213 to 216 of combination 230 has a period of four spatial units 231 and is repeated after each four spatial units 231, respectively. The pattern of each two adjacent rows (e.g. rows 213 and 214) are dephased by one spatial unit 231 which equals to 90 electrical degrees, if the repetition period of four units 231 is considered to represent 360 electrical degrees.

In FIG. 3A, a combination 300 is shown which is obtained when placing sector 220 of the codewheel (in the status shown in FIG. 2C) on combination 230 shown in FIG. 2D. The combination 300 shown in FIG. 3A relates to a position of the codewheel 220 as shown in FIG. 2C. When being moved, the codewheel 220 will generate different patterns as shown in FIG. 3B to FIG. 3D, as will be explained below.

When forming combination 300, encoding elements 221, 222 of the codewheel 220, filter elements 211, 212 of the encoding filter 210 and the two pairs of photodiodes 201 and 203, 202 and 204 are arranged relative to each other such that the photodiodes of each pair can be complementarily illuminated with light transmitted through the codewheel 220 and the encoding filter 210. Referring to FIG. 3A, for instance, due to the present relative orientation of the components, light which is illuminated on combination 300 impinging on the paper plane illuminates four regions of the first photodiode 201. However, the third photodiode 203 being the complementary photodiode to the first photodiode 201 is free from an illumination by light, as all the portions of the third photodiode 203 are either covered by opaque encoding elements 222 or by opaque filter elements 212. Therefore, the illumination of the first and third photodiodes 201, 203 is complementary. Also the illumination of the second and the fourth photodiodes 202, 204 forming the second pair of photodiodes, is complementary. As can be seen from FIG. 3A, four portions of the second photodiode 202 can be illuminated, wherein all corresponding portions of the fourth photodiode 204 are covered by opaque encoding elements 212. On the other hand, the four portions of the fourth photodiode 204 which are illuminated by light in the configuration shown in FIG. 3A are not illuminated in the second photodiode 202. Thus, photodiodes 202 and 204 are illuminated in a complementary way. In other words: one of each two filter elements 211, 212 corresponding to two of the photodiodes 201 to 204 grouped to a pair, respectively, and being in alignment with a respective one of encoding elements 221, 222 is opaque and the other one is transparent. Thus, the encoding elements 221, 222 of the codewheel 220, the filter elements 211, 212 of the encoding filter 210 and the two pairs of photodiodes 201, 203 and 202, 204 are arranged relative to each other such that the photodiodes of the pairs can be complementarily illuminated with light transmitted through the codewheel 220 and the encoding filter 210.

FIG. 3B to FIG. 3D show configurations of the combination 300 in scenarios in which the codewheel 220 is rotated by 90 electrical degrees (FIG. 3B), 180 electrical degrees (FIG. 3C) and 270 degrees (FIG. 3D), respectively, compared to the configuration shown in FIG. 3A. A rotation of the codewheel by 360 electrical degrees compared to FIG. 3A brings back the scenario which is shown in FIG. 3A. A rotation of 90 electrical degrees corresponds to a motion of the codewheel of half the lateral width of the opaque or transparent encoding elements 221, 222 (or of one spatial unit 231). As shown in FIG. 3A to FIG. 3D, rotating the codewheel 220 according to the offset placed by the encoding filter 210, the area of each of the photodiodes 201 to 204 is totally covered, half covered or quarterly covered. The illumination stages of the photodiodes 201 to 204 as the codewheel rotates by 90 electrical degrees for four sequential steps, can be seen in FIG. 3A to FIG. 3D.

FIG. 4A is a diagram showing schematically the intensity as detected by photodiodes 201 to 204 as a function of the rotation status of the codewheel 220. The rotation progress is shown on the abszissa of FIG. 4A. Particularly, the rotation status of the codewheel 220 is indicated in FIG. 3A to FIG. 3D as t₁, t₂, t₃, t₄. These rotation statuses are also shown on the abszissa of the diagram shown in FIG. 4A. The diagram of FIG. 4A further contains four curves 401 to 404 reflecting the detection signals of the first to fourth photodiodes 201 to 204. The detection signal 401 of the first photodiode 201, the detection signal 402 of the second photodiode 202, the detection signal 403 of the third photodiode 203 and the detection signal 404 of the fourth photodiode 204 are shown in FIG. 4A.

In rotation status t₁, the first photodiode 201 is covered only half by the opaque encoding elements 222 of the codewheel 220, and as a consequence the detection signal of the first photodiode 201 is half of the maximum value. The detection signals 402, 404 of the second and the fourth photodiodes 202, 204, respectively, are located at the quarter-level, as only a quarter of the surface area of photodiodes 202, 204 is free for being illuminated by light. The third photodiode is completely covered by the opaque filter elements 212 and the opaque encoding elements 222, such that the detection signal of the third photodiode 403 is at the lowest possible value in rotation status t₁. As the rotation progresses, the photodiode's status or detection signals 401 to 404 are evolving from zero to half or vice versa. The result is a detection signal with a zigzag waveform, as shown in FIG. 4A.

However, although not shown in FIG. 2A to FIG. 4C, the optical encoder device according to the preferred embodiment further comprises an estimation unit coupled to the photodiodes 201 to 204, such that the detection signals 401 to 404 from the pairs of photodiodes 201 and 203, 202 and 204 can be provided to the estimation unit, whereas the estimation unit is adapted to estimate a motion information, which is characteristic for a motion of the rotated codewheel 220, based on the detection signals 401 to 404 of the two pairs of photodiodes 201 and 203, 202 and 204. As will be described in the following, the estimation of the estimation unit is based on a correlation of the detection signals 401 and 403, 402 and 404 of the pairs 201, 203 and 202, 204 of photodiodes. To perform this functionality, the estimation unit comprises a transistor-transistor-logic-circuit (TTL-circuit).

In FIG. 4B a diagram 410 is illustrated showing a first estimation signal 411 obtained from a correlation of detection signals 401, 403. Through electronic circuitry, the waveforms of detection signals 401, 403 are converted into the first estimation signal 411. The electronic system compares the detection signals of the pair of photodiodes 401, 403, i.e. compares detection signal 401 with the complementary detection signal 403 and, based on the electronic offset between those two detection signals 401, 403, transfers the results into respective TTL-output (transistor-transistor logic). The “high” and “low” transition happens at the intersection of the detection signals 401, 403 at rotation status t₂.

As can be retraced from FIG. 4A, FIG. 4B, first estimation signal 411 is “high”, if detection signal 401 is above detection signal 403, and first estimation signal 411 is “low”, if detection signal 401 is below detection signal 403.

Accordingly, the estimation unit estimates a second estimation signal 421 shown in the diagram 420 of FIG. 4C by correlating the second and fourth detection signals 402, 404 of the second and fourth photodiodes (complementary photodiodes) 202, 204.

The time difference between two consecutive pulses (duty cycle) of the first and second estimation signals 411, 421 is characteristic for the rotation velocity of the codewheel 220. A motion information can therefore be estimated. The digital-like first and second estimation signals 411, 421 have a significantly improved signal-to-noise ratio. Therefore, the resolution of the optical encoder according to the preferred embodiment of the invention is substantially improved compared to prior art solutions.

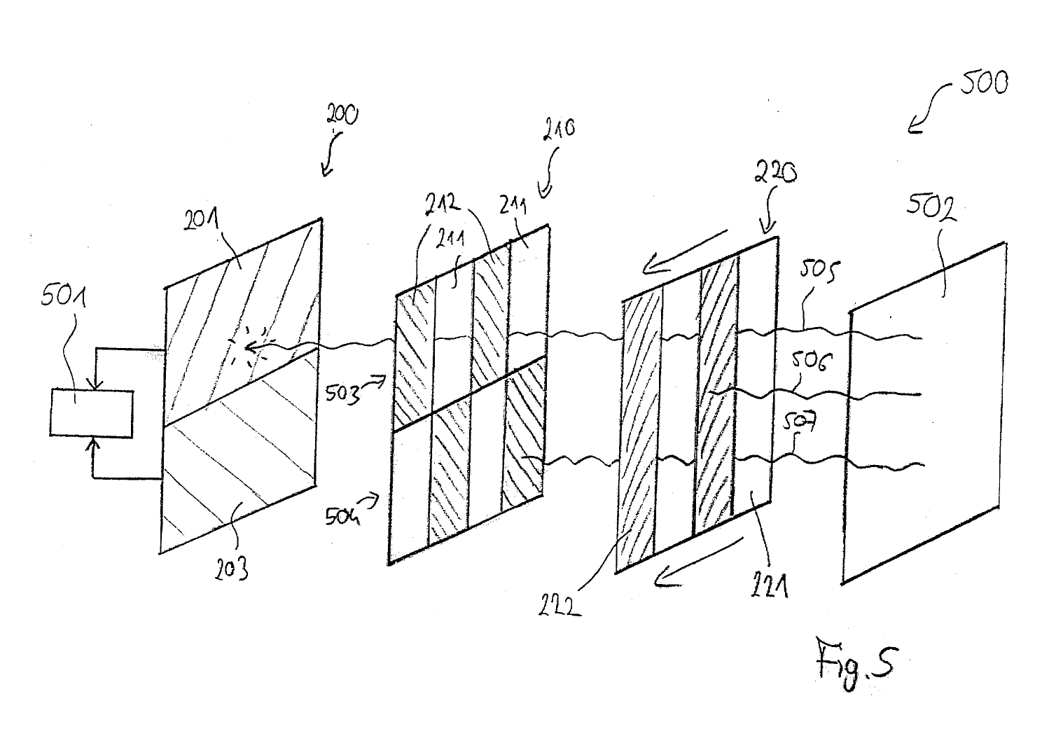

In the following, a further preferred embodiment of the optical encoder arrangement of the invention will be explained referring to FIG. 5.

The optical encoder arrangement 500 shown in FIG. 5 comprises a codewheel (a sector 220 of the codewheel is shown in FIG. 5) comprising a plurality of alternating transparent encoding elements 221 and opaque encoding elements 222 and being arranged such that at least a part of the encoding elements 221, 222 (the sector shown in FIG. 5) can be illuminated with light. The optical encoder arrangement 500 further comprises two photodiodes 201, 203 grouped to a pair. Further, the optical arrangement 500 comprises an encoding filter 210, comprising a plurality of alternating transparent filter elements 211 and opaque filter elements 212, wherein the encoding elements 221, 222 of the codewheel 220, the filter elements 211, 212 of the encoding filter 210 and the pair of photodiodes 201, 203 are arranged relative to each other such that the photodiodes 201, 203 can be complementarily illuminated with light transmitted through the codewheel 220 and the encoding filter 210. Moreover, the optical encoder arrangement 500 comprises an estimation unit 501 coupled to the photodiodes 201, 203 such that detection signals 401, 403 from the pair of photodiodes 201, 203 can be provided to the estimation unit 501 wherein the estimation unit 501 is adapted to estimate a motion information, which is characteristic for the motion of the codewheel 220, based on the detection signals 401, 403 of the pair of photodiodes 201, 203. Beyond this, the optical encoder arrangement 500 comprises a light-emitting diode 502 as a light source arranged such that it is capable of emitting light onto the encoding elements 221, 222 of the sector 220.

The number of photodiodes 201, 203 is two. Further, all photodiodes 201, 203 are grouped to a single pair. As can be seen from FIG. 5, photodiodes 201, 203 are aligned along a direction which is generally perpendicular to an alignment direction of the encoding elements 211, 212. The encoding filter 210 comprises a first row 503 and a second row 504, each row 503, 504 corresponding to and being in alignment with one of the photodiodes 201, 203, each row 503, 504 comprising a plurality of alternating transparent filter elements 211 and opaque filter elements 212 arranged generally parallel to the encoding elements 221, 222 and such that one of each two filter elements 211, 212 corresponding to the two photodiodes 201, 203 coupled to a pair and being in alignment with a respective one of the encoding element 221, 222 is opaque and the other one is transparent. The encoding filter 210 is arranged between the array of photodiodes 200 and the codewheel 220. The codewheel 220 is adapted to perform a rotational motion.

A first light beam 505, a second light beam 506 and a third light beam 507 are shown in FIG. 5. According to the present rotation status of the codewheel 220, the first light beam 505 can pass through one of the transparent encoding elements 221 of the codewheel, can pass through one of the transparent filter elements 211 of the encoding filter 210 and impinges on the first photodiode 201 to produce a corresponding electric signal. In contrast to this, the second light beam 506 is impinged on one of the opaque encoding elements 222 of the codewheel 220 and cannot reach one of the photodiodes 201, 203. The third light beam 507 can pass through the codewheel 220 by passing through one of the transparent encoding elements 221 of the codewheel 220, but the third light beam 507 impinges on one of the opaque filter elements 212 of encoding filter 210 and is therefore not able to reach one of the photodiodes 201, 203 to produce a signal.

In the following, further features of preferred embodiment of the optical encoder device will be described. The number of optical detecting elements of the optical encoder device can be even, further preferably can be two or four. The transparent encoding elements can be slotted portions and the opaque encoding elements can be non-slotted portions of a solid body. Alternatively, opaque portions can be printed portions on a basically optical transparent body, and transparent portions can be portions between the printed opaque portions. The movable optical encoding unit can be adapted to perform a rotational or a translational motion. “Light” in the context of the invention can be electromagnetic radiation of any wavelength, particularly visible light, ultra-violet radiation and/or infrared light, for instance. The optical encoder device of the invention can be used in a printer (e.g. an inkjet printer), in a copy machine, in a fax machine, in a scanner, for example.

According to a preferred embodiment of the method for estimating a motion information, the method further comprises the step of detecting, by the at least one pair of optical detecting elements, a time-dependence of signals generated by light transmitted through the optical encoding unit and through the encoding filter and impinged on the optical detecting elements, the step of estimating a correlation signal based on the detected signals of the at least one pair of optical detecting elements and the step of estimating the motion information based on the correlation signal.

What is claimed is:

1. An optical encoder device, comprising:
a movable optical encoding unit having a plurality of alternating transparent and opaque encoding elements, arranged so that at least a part of the encoding elements can be illuminated with light;
at least two optical detecting elements;
an encoding filter having a plurality of alternating transparent and opaque filter elements, wherein the encoding elements of the optical encoding unit, the filter elements of the encoding filter and the at least one pair of optical detecting elements are arranged relative to each other such that the optical detecting elements of the pair are complementarily illuminated with light transmitted through the optical encoding unit and the encoding filter; and
an estimation unit coupled to the optical detecting elements so that detection signals from the at least two optical detecting elements are provided to the estimation unit, wherein the estimation unit estimates motion information, which is characteristic for a motion of the movable optical encoding unit, based on the detection signals.

2. The optical encoder device of claim 1 further comprising a light source arranged to emit light onto at least a part of the encoding elements.

3. The optical encoder device of claim 1 wherein the number of the optical detecting elements is even.

4. The optical encoder device of claim 3 wherein the optical detecting elements are grouped to pairs.

5. The optical encoder device of claim 1 wherein the optical detecting elements are aligned along a direction which is generally perpendicular to an alignment direction of the encoding elements.

6. The optical encoder device of claim 1 wherein the encoding filter includes a number of rows, each row corresponding to and being in alignment with one of the optical detecting elements, each row comprising a plurality of alternating transparent and opaque filter elements arranged generally parallel to the encoding elements and such that one of each two filter elements corresponding to two of the optical detecting elements grouped to a pair and being in alignment with a respective one of the encoding elements, is opaque and the other one is transparent.

7. The optical encoder device of claim 1 wherein the encoding filter is arranged between the optical detecting elements and the optical encoding unit.

8. The optical encoder device of claim 1 wherein the estimation of the estimation unit is based on a correlation of the detection signals of the pair of optical detecting elements.

9. The optical encoder device of claim 1 wherein the estimation of the estimation unit is based on an electronic offset between the detection signals of the pair of optical detecting elements.

10. The optical encoder device of claim 9 wherein the estimation unit comprises a transistor-transistor-logic-circuit.

11. The optical encoder device of claim 1 wherein the movable optical encoding unit is adapted to perform a rotational or a translational motion.

12. The optical encoder device of claim 1 wherein the movable optical encoding unit is a codewheel or a codestrip.

13. The optical encoder device of claim 1 wherein at least one of the optical detecting elements is a photodiode.

14. The optical encoder device of claim 2 wherein the light source is a light-emitting diode (LED).

15. The optical encoder device of claim 1 wherein the width of the encoding elements generally equals to the width of the filter elements.

16. The optical encoder device of claim 6 wherein a first pair of the optical detecting elements is formed by optical detecting elements aligned with a first and a third row of the encoding filter and wherein a second pair of optical detecting elements is formed by optical detecting elements aligned with a second and a fourth row of the encoding filter, and wherein corresponding filter elements of the first and the second row are dephased relative to each other by the half of a width of the filter elements.

17. The optical encoder device of claim 6 wherein a predetermined degree of dephasing between corresponding filter elements of adjacent rows of the encoding filter is based on the ratio between the lateral overlap of corresponding filter elements of adjacent rows of the encoding filter and the width of the filter elements.

18. The optical encoder device of claim 2 further comprising a generally C-shaped housing having a first and a second inner surface which are generally parallel to each other, wherein the optical detecting elements are provided on the first surface, the light source is provided on the second surface, at least a part of the optical encoding unit is arranged in a free space between the first and second surface of the generally C-shaped housing.

19. The optical encoder device of claim 18 wherein the encoding filter is provided on the optical detecting elements on the first surface of the housing.

20. The optical encoder device of claim 1 wherein the transparent encoding elements are slotted portions and wherein the opaque encoding elements are non-slotted portions of a solid body.

21. An optical encoder arrangement, comprising:
a movable optical encoding unit comprising a plurality of alternating transparent and opaque encoding elements and being arranged such that at least a part of the encoding elements can be illuminated with light;
at least two optical detecting elements grouped to at least one pair;
an encoding filter comprising a plurality of alternating transparent and opaque filter elements, wherein the encoding elements of the optical encoding unit, the filter elements of the encoding filter and the at least one pair of optical detecting elements are arranged relative to each other such that the optical detecting elements of the pair can be complementarily illuminated with light transmitted through the optical encoding unit and the encoding filter;
an estimation unit coupled to the optical detecting elements such that detection signals from at least the pair of optical detecting elements can be provided to the estimation unit, wherein the estimation unit is adapted to estimate a motion information, which is characteristic for a motion of the movable optical encoding unit, based on the detection signals of the pair of optical detecting elements; and
a light source arranged such that it is capable of emitting light onto at least a part of the encoding elements.

22. A method for estimating a motion information, which is characteristic for a motion of a movable optical encoding unit of an optical encoder device, the optical encoder device comprising:
a movable optical encoding unit comprising a plurality of alternating transparent and opaque encoding elements and being arranged such that at least a part of the encoding elements can be illuminated with light;
at least two optical detecting elements grouped to at least one pair;
an encoding filter comprising a plurality of alternating transparent and opaque filter elements, wherein the encoding elements of the optical encoding unit, the filter elements of the encoding filter and the at least one pair of optical detecting elements are arranged relative to each other such that the optical detecting elements of the pair can be complementarily illuminated with light transmitted through the optical encoding unit and the encoding filter; and
an estimation unit coupled to the optical detecting elements such that detection signals from at least the pair of optical detecting elements can be provided to the estimation unit, wherein the estimation unit is adapted to estimate a motion information, which is characteristic for a motion of the movable optical encoding unit, based on the detection signals of the pair of optical detecting elements;
the method comprising illuminating at least a part of the encoding elements with light, providing detection signals from at least the pair of optical detecting elements to the estimation unit, and estimating a motion information, which is characteristic for a motion of the movable optical encoding unit, based on the detection signals of the pair of optical detecting elements.

23. The method for claim 22 further comprising
detecting, by the at least one pair of optical detecting elements, a time-dependence of signals generated by light transmitted through the optical encoding unit and through the encoding filter and impinged on the optical detecting elements;
estimating a correlation signal based on the detected signals of the at least one pair of optical detecting elements;
estimating the motion information based on the correlation signal.
